(19) United States
(12) Patent Application Publication
(10) Pub. No.: US 2025/0232050 A1
(43) Pub. Date: Jul. 17, 2025

(54) SYSTEM AND METHOD FOR IMPLEMENTING DISTRIBUTED ENCRYPTED DATABASE ACROSS DATABASE NODES OF DISTRIBUTED SERVER NETWORK

(71) Applicant: Valarian Technologies Limited, London (GB)

(72) Inventors: Maximilian Alastair Buchan, London (GB); Dima Rozhdestvenskiy, London (GB)

(21) Appl. No.: 18/412,659

(22) Filed: Jan. 15, 2024

(51) Int. Cl. G06F 21/62; G06F 16/27; G06F 21/60

(52) U.S. Cl. CPC G06F 21/6218; G06F 16/27; G06F 21/602

(57) ABSTRACT

Disclosed is a system for implementing a distributed encrypted database across database nodes of a distributed server network. The system comprises at least one server. The at least one server is configured to execute a database management system to configure at least one database node of the distributed encrypted database with a first software to provide automated failover and replication capabilities in the distributed encrypted database. Moreover, the database management system is executed to integrate a second software with the database management system and encrypt data at rest in a distributed encrypted database by employing the second software; and integrate a third software with a first platform that is capable of authenticating users of the distributed encrypted database for controlling access to the encrypted files. Disclosed also is a method for implementing a distributed encrypted database across database nodes of a distributed server network.

### TECHNICAL FIELD

The present disclosure relates to systems for implementing distributed encrypted databases across database nodes of distributed server networks. Moreover, the present disclosure relates to computer-implemented methods for implementing distributed encrypted databases across database nodes of distributed server networks. Furthermore, the present disclosure relates to computer program products comprising non-transitory machine-readable data storage mediums having stored thereon program instructions that, when executed by processors, cause the processors to execute the steps of the aforementioned computer-implemented methods.

### BACKGROUND

With increasingly occurring instances of cyber-attacks, data theft, data breaches, and similar, organizations are employing several solutions for ensuring data privacy and security. Presently, the use of encrypted databases for storing data is gaining popularity since encryption effectively secures databases and protects the data. For encrypting a database, an encryption algorithm is employed to convert data in the database from plain text to cipher text (i.e., unreadable text), and only a key generated using the encryption algorithm can decrypt the cipher text.

Encrypted databases, however, suffer from several limitations. For example, many existing encrypted databases are currently not scalable. The encrypted databases used nowadays are single-node databases and the data contained within them is not replicable, making organizations vulnerable if such encrypted databases are compromised or destroyed. Traditionally, all data is stored in a single centralized server or single location, and if that location experiences any kind of hardware failure, software issue, power outages or any other problem, the entire database becomes unavailable. Moreover, such encrypted databases are vulnerable to internal attack. Such reliance on a single server increases the risk of cyber-attacks.

A conventional common approach is that the data (for example, in the form of files) in the encrypted databases is encrypted prior to storage in said databases, and not when added to said databases. However, as a result, analysis cannot be carried out on the encrypted databases generated in this manner. Moreover, when data encryption is performed in the database, the encrypted data is generally not shareable. Currently, encryption by default in cloud-based databases is possible, but this creates a new problem of data governance, and there is no guarantee as to where the encrypted data is stored within the cloud.

Therefore, in light of the foregoing discussion, there exists a need to overcome the aforementioned drawbacks.

### SUMMARY

The aim of the present disclosure is to provide a system and computer-implemented method to provide data security and scalability in a distributed encrypted database. The aim of the present disclosure is achieved by a system and computer implemented method for implementing a distributed encrypted database across database nodes of a distributed server network as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a system for implementing a distributed encrypted database across database nodes of a distributed server network, in accordance with an embodiment of the present disclosure; and

FIG. 2 is an illustration of a computer-implemented method for implementing a distributed encrypted database across database nodes of a distributed server network, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a system for implementing a distributed encrypted database across database nodes of a distributed server network, the system comprising at least one server configured to execute a database management system to:
configure at least one database node of the distributed encrypted database with a first software to provide automated failover and replication capabilities in the distributed encrypted database;
integrate a second software with the database management system and encrypt data at rest in distributed encrypted database by employing the second software; and
integrate a third software with a first platform that is capable of authenticating users of the distributed encrypted database for controlling access to the encrypted files.

The distributed encrypted database enhances data security and privacy by protecting sensitive information, enabling secure data sharing, and facilitating decentralized access control across a network server. The network server distributes the encryption keys to nodes within the distributed network by ensuring that only authorized nodes receive the encryption keys.

In a second aspect, the present disclosure provides a computer-implemented method for implementing a distributed encrypted database across database nodes of a distributed server network, the method comprising executing a database management system for:
configuring at least one database node of the distributed encrypted database with a first software for providing automated failover and replication capabilities in the distributed encrypted database;
integrating a second software with the database management system and encrypting data at rest in distributed encrypted database by employing the second software; and
integrating a third software with a first platform that is capable of authenticating users of the distributed encrypted database for controlling access to the encrypted files.

The disclosed method ensures enhanced data security and data privacy by protecting sensitive information by providing access to the data to only authorized personnels, thereby mitigating the risk of data breaches and unauthorized data access. In this regard, the method employs a plurality of software, namely the first, second and third software, to configure encryption keys for encrypting and decrypting the data, which are available to only the authorized personnels.

In a third aspect, the present disclosure provides a computer program product comprising a non-transitory machine-readable data storage medium having stored thereon program instructions that, when executed by a processor, cause the processor to execute the steps of the computer-implemented method of the second aspect.

Herein, the term “database” refers to a structured collection of data organized and stored in a way such that it can be easily accessed, retrieved, managed, and updated. The database is designed to handle large amounts of data and provide mechanisms for querying, updating, and manipulating that data. Here, the data refers to statically raw and unprocessed information. In this context, the data refers to both sensitive and non-sensitive information that are securely stored, managed, and accessed within a distributed encrypted database.

Throughout the present disclosure, the term “distributed encrypted database” refers to a database that combines features of distribution and encryption of data to ensure security and scalability across multiple database nodes. A technical effect of implementing the distributed encrypted database is that it enhances data security, and confidentiality by ensuring its availability and scalability. The combination of distribution and encryption provides a robust, reliable, and secure database system solution for organizations that require secure and scalable data storage across multiple database nodes, while protecting sensitive information from unauthorized access and maintaining data integrity.

In the distributed encrypted database, data is distributed across multiple database nodes in the distributed server network. In this regard, the distributed server network comprises a plurality of servers that serve as database nodes of the distributed server network. The data is stored across multiple nodes, each contributing to the overall functionality of the database. Each database node stores a portion of the distributed encrypted database. This distribution of databases helps in improving performance, scalability, and fault tolerance. Moreover, the distributed encrypted database employs an encryption concept by which the data is encrypted before it is stored in the database. Encryption ensures that even if an unauthorized person gains access to the physical storage, the data remains in an encrypted and unreadable state without the appropriate decryption keys.

Throughout the present disclosure, the term “database nodes” refers to individual servers or computing devices that collectively form the distributed database system. A database node can be a physical computing device or machine or a virtual server with its own processing power, memory storage and networking capabilities. A database node runs the necessary software to manage and store a given portion of the database corresponding to (or associated with) that database node. It will be appreciated that the database nodes store the data in their local storage or disks. This data is organized and managed by the database management system (DBMS).

Moreover, the distributed encrypted database implements data replication where copies of data are stored on multiple database nodes.

This replication of data ensures fault tolerance and high availability. If one database node fails, the data can be accessed from its replicas on other database nodes.

Herein, the database management system is software that is designed to manage and organize data in a structured manner. The DBMS allows users to create, modify and query the distributed encrypted database, as well as manage the security and access controls for the distributed encrypted database. The DBMS is responsible for handling various aspects of database operations, including data storage, retrieval, encryption, and management, while also integrating with other components to ensure data security, availability, and optimal performance. The DBMS acts as an intermediary between other software applications and the distributed encrypted database, providing an interface to interact with the distributed encrypted database.

In particular, the DBMS determines how the data is distributed across the database nodes, how it is replicated or partitioned, and how it is accessed and processed. It will be appreciated that the number of database nodes in the distributed encrypted database can vary depending on the specific requirements, architecture, and scale of the system. Moreover, adding or removing database nodes can be done dynamically by the DBMS to adapt to changing needs or to address hardware failures or capacity constraints. Beneficially, distributing data across the database nodes provides scalability, fault tolerance, load balancing, and high availability of data.

Optionally, the distributed server network is a part of a larger distributed network, including at least one other network device in addition to the plurality of servers (that serve as database nodes of the distributed server network). The larger distributed network can be understood to be a collection of interconnected devices that work together to provide a distributed computing environment. Examples of network devices include, but are not limited to, computing servers (i.e., computing devices), the database nodes, routers and switches, load balancers, firewalls and security devices, and client devices.

In some implementations, the at least one server comprises a single server, whereas in other implementations, the at least one server comprises a plurality of servers. The at least one server refers to the computer program or hardware device that provides services or resources to the other programs within a network. Moreover, the at least one server comprises at least one of: a server from amongst the plurality of servers of the distributed server network, an external server, a virtual machine. The external server may, for example, be a cloud-based server, a host server and similar.

In the present context, a primary DBMS used is PostgreSQL. PostgreSQL is an open source, powerful and widely used relational database management system (RDBMS) that manages and controls the database. The RDBMS is a type of a DBMS that stores data in a row-based tabular structure which connects related data elements. Most RDBMS use the SQL programming language-based algorithm to access the database. Beneficially, PostgreSQL offers features and optimization mechanisms that enhance performance and scalability in the database. Alternatively, optionally, the DBMS may be MySQL, Oracle Database, MongoDB, and Microsoft SQL Server.

Moreover, the DBMS is executed to configure at least one database node of the distributed encrypted database with a first software to provide automated failover and replication capabilities in the distributed encrypted database. Herein, the term “first software” is implemented as Patroni. Patroni is an open-source software tool used for managing high-availability configurations for PostgreSQL databases. It is designed to automate failover and replication in a PostgreSQL cluster, ensuring continuous availability and improved reliability of the distributed encrypted database. Patroni is implemented on at least one database node of the distributed encrypted database to automate the failover process and manages the replication process, ensuring that standby nodes (replicas) remain synchronized with a primary node. Patroni is installed on each node in the distributed database system as a standalone package or containerized within docker images. Herein, the “docker image” is a lightweight, standalone, executable package that includes everything needed to run a piece of software, including the code, runtime, system tools, system libraries, and settings. The process begins with the launch of a docker image, which contains the necessary software components for a distributed encrypted database. Furthermore, Patroni is configured with specific settings for each database node configuration files specify details such as the node's role (primary or replica), database connection parameters, replication settings, and failover criteria. Moreover, such specific settings define how Patroni should operate on each node. The configuration file for each node clearly defines its role within the distributed database. Patroni coordinates elections to determine which replica node should become the new primary node during a failover. When a failover is initiated, Patroni orchestrates the promotion of a replica node to become the new primary. However, if Patroni is not the primary node (main), a ‘pg_basebackup’ process is initiated. The pg_basebackup process is responsible for creating a backup of the primary node's database. Additionally, Patroni may initiate a ‘waldump’ process to capture changes in the Write-Ahead Log (WAL). Beneficially, these steps are necessary for replicating the data from the main node to the new node and maintaining data consistency. After obtaining the necessary data through pg_basebackup and waldump, Patroni uses the encryption key to unlock the encrypted data. Once the data is decrypted, Patroni can join the cluster and become a replica node, ensuring data consistency and redundancy. Notably, such synchronization maintains data consistency and availability. Patroni continuously monitors the health and status of the database nodes. In this regard, the implementation of the first software in the system provides a technical advantage by enhancing the reliability and robustness of the distributed encrypted database.

Furthermore, the DBMS is executed to integrate a second software with the database management system and encrypt data at rest in a distributed encrypted database by employing the second software. Optionally, the system utilizes Cybertec as the second software for encrypting data at rest in a distributed encrypted database. The Cybertec plugin applies an encryption algorithm to secure the data. By integrating the second software, such as Cybertec, with the database management system, the system ensures that the data at rest (namely, data stored in the distributed encrypted database) remains secure and unreadable to unauthorized users. Optionally, the data at rest may include tables, or any other structured records. The second software is configured to automatically encrypt the data at rest before storing it on disk, and decrypt when reading from the disk. Applications can access the data as they normally would, and the encryption and decryption processes are handled seamlessly by the plugin. The integration of the second software with the database management system provides an efficient and reliable solution for encrypting data at rest, thereby addressing the need for secure data storage in distributed environments.

Furthermore, the DBMS is executed to integrate a third software with a first platform that is capable of authenticating users of the distributed encrypted database for controlling access to the encrypted files. Herein, the third software may be implemented as a modified version of Envcosnul. Envconsul is a software tool that facilitates the integration of Consul, a distributed key-value store and service discovery platform, with applications running on a host, such as the distributed encrypted database. Envconsul allows applications to access configuration data stored in Consul and assign environment variables with the corresponding values. Envconsul operates as a bridge between applications and Consul, ensuring that the application environment is populated with the most up-to-date configuration values stored in Consul's key-value store. It provides a convenient way to manage application configuration, eliminate the need for manual configuration file updates, and enable dynamic configuration updates without application restarts. The modified version of Envconsul is integrated with the first platform which is implemented as Kubernetes in the present disclosure. Kubernetes is an open-source container orchestration or management platform that automates and manages the deployment, scaling, and management of containerized applications. A containerized application is a software application that has been packaged with its dependencies, libraries, and runtime components into a standardized unit. The integration of the third software, such as Envconsul, with the first platform, such as Kubernetes, enables efficient and secure user authentication, thereby enhancing the overall security and access control capabilities of the distributed encrypted database. This provides a novel and advantageous solution for managing user authentication in a distributed encrypted database.

It will be appreciated that integration of the second software and the third software with the database management system and the first platform, respectively, is achieved by means of various methods and technologies known to a person skilled in the art. Such methods and technologies may include software drivers and Application Programming Interfaces (APIs; e.g., ODBC (Open Database Connectivity) and JDBC (Java Database Connectivity)), ORM tools like Hibernate (for Java) and Entity Framework (for .NET), Web APIs (e.g., RESTful APIs or GraphQL APIs, SOAP, etc.), Middleware software (e.g., Apache Camel, MuleSoft, and IBM WebSphere), Message queue systems (like RabbitMQ, Apache Kafka, or AWS SQS), data integration tools (like Apache NiFi, Talend, and Informatica), and custom integration solutions.

Optionally, the data at rest in a distributed encrypted database is encrypted using a transparent data encryption algorithm. Notably, transparent data encryption is a method of encrypting data within a database in such a way that the encryption and decryption process are handled automatically and transparently for the DBMS and the user to access the data. Optionally, the transparent data encryption algorithm is an Advanced Encryption Standard (AES) algorithm, a Triple Data Encryption Standard (3DES) algorithm, a Rivest Cipher (RC) algorithm, Blowfish algorithm, and a TwoFish algorithm. Optionally, the transparent data encryption algorithm is an Advanced Encryption Standard (AES) algorithm. AES is a widely recognized and respected symmetric encryption algorithm utilized to encrypt the data at rest within the distributed encrypted database. Optionally, the AES may include RSA (Rivest-Shamir-Adleman) algorithm, ECC (Elliptic Curve Cryptography), or similar. The choice of AES algorithm depends on various factors such as security requirements, performance, compatibility, and industry standards. The transparent data encryption algorithm ensures that sensitive data, namely the data at rest, remains confidential and protected against unauthorized access, even if an unauthorized party gains access to the physical storage medium. Moreover, employing a transparent data encryption algorithm aligns with the system's objective to enhance data security and confidentiality within the distributed encrypted database.

Optionally, at least one server is configured to execute the database management system to further retrieve at least one encryption key that is employed to encrypt the data at rest, from a centralized repository. It may be appreciated that, beneficially, the database management system does not store the encryption key itself, but rather retrieves it from a HashiCorp Vault during the process, for ease of management and safety of the encryption key. HashiCorp Vault is an open-source tool designed to serve as a central repository for securely storing (and allowing authorized accessing) of sensitive data, such as credentials, tokens, passwords, certificates, API keys, and other secrets, for different systems, services, and platforms. This approach ensures enhanced security and confidentiality of the data, as the encryption key remains separate from the database management system. By utilizing a centralized repository for the encryption key, the system offers improved scalability and flexibility, allowing for efficient management of encryption keys across multiple database nodes.

Optionally, the at least one server is further configured to generate at least one customized policy for centralized key management at the centralized repository, wherein the at least one customized policy is employed when retrieving the at least one encryption key from the centralized repository. Notably, at least one customized policy is associated with the centralized repository, such as HashiCorp Vault. The server generates at least one customized policy, such as HashiCorp Vault policy, when interacting with the centralized repository, such as HashiCorp Vault, when retrieving the encryption keys. In this regard, the distributed encrypted database is not configured to create (or generate) the at least one customized policy, rather the at least one customized policy is generated by any other component of the at least one server, for example, a processing device thereof.

It may be appreciated that centralized key management based on at least one customized policy provides controlled access to data, even for system administrators, thereby, making it particularly suitable for organizations such as hospitals or banks that require both security and accessibility.

Optionally, the database management system applies a patch to the third software, prior to integrating the third software with the first platform. Herein, the term “patch” refers to a piece of code or software that is designed to update or fix issues in an existing program, operating system, or software application. Beneficially, patches are released to address security vulnerabilities, software bugs, performance improvements, or compatibility issues. Referring to above examples of the third software and the first platform, the patching activity is conducted before integrating the Envconsul (an example of the third software) with the Kubernetes (an example of the first platform). The first step is to locate the source code of Envconsul which can be found in the repository or codebase of the Envconsul project. The patch is created by making code modifications that enable Kubernetes authentication. These changes are made to the source code files of Envconsul. The specific modifications will depend on the requirements for integrating Kubernetes authentication. After applying the patch, the modified code is thoroughly tested and validated to ensure that it functions as expected and doesn't introduce any issues or vulnerabilities. Testing may involve running the patched Envconsul in a controlled environment. Once the code modifications are complete and tested, the patched code is compiled or built to create an executable version of Envconsul with the new functionality. Moreover, the patched version of Envconsul is integrated into the Docker images used for deployment to ensure that each database node in the distributed system has the patched Envconsul as part of its environment. Herein, the database management system ensures compatibility, security enhancements, or tailored modifications that optimize the integration of the Envconsul software with the Kubernetes.

Optionally, the at least one server is configured to execute the database management system to further:
receive an access request from a client device, wherein the access request comprises credentials of a user;
send an authentication request comprising the credentials, to the first platform that is capable of authenticating users of the distributed encrypted database; and
upon receiving a response indicative of successful authentication of the credentials from the first platform, grant the user with access to the encrypted files.

The term “client device” as used herein refers to a computing device or application associated with a client or a user of the system, configured for requesting services or resources (including, but not limited to, accessing data, applications, etc.) from at least one server in a client-server architecture. In this regard, the client device and the at least one server are communicably coupled and interact with each other through network protocols and software applications. Optionally, the client devices include any of: personal computers and laptops (running operating systems like Windows, macOS, or Linux), smartphones and tablets (running operating systems like iOS (Apple), Android (Google), and others), smart TVs and streaming devices (e.g., Apple TV, Roku, Amazon Fire Stick), gaming consoles like Xbox, PlayStation, and Nintendo Switch, wearables such as smartwatches, fitness trackers, and augmented reality (AR) glasses, e-readers like Amazon, Kindle, IoT devices such as smart thermostats, smart speakers, and connected appliances, Kiosks and POS terminals. Herein, the client or user may be an individual, a BOT, or an application.

The term “authentication request” as used herein refers to a step in a process of verifying the identity of a user or another system (such as BOT or application) attempting to access a given data. Notably, authentication ensures that only authorized individuals or entities have access to sensitive information, systems, or services, and the authentication request initiates the authentication mechanism. Optionally, authentication requests include passwords, biometrics, multi-factor authentication (MFA), and token-based authentication.

Optionally, the access request is received from a client device via a user interface (UI) implemented thereon. In this regard, the user is requested to provide credentials thereof to the database management system for further authentication (or processing) of the credentials of the user. Alternatively, optionally, the access request is received from historical data saved on the DBMS or a memory unit coupled to the DBMS. In this regard, the DBMS or a memory unit coupled to the DBMS is searched for the credentials of the user for further authentication (processing).

Optionally, the credentials comprise at least one of: a client certificate, an authentication token, a user identification, information related to a service account, information related to a role-based access control. Typically, the credentials include identification information, usually in the form of a username, email, or unique identifier, to the system. It may be appreciated that the credentials represent diverse authentication methods available for users and client devices to gain authorized access to the encrypted files within the distributed encrypted database.

The authentication request comprising the credentials is sent to the first platform that is capable of authenticating users of the distributed encrypted database by the DBMS to receiving a response from the client device via the UI or the historical data stored on the DBMS. The validation or authentication typically involves checking the entered credentials (e.g., password) against the stored credentials in a secure database or directory. If the credentials match, the authentication server proceeds to the next step.

The first platform is configured to notify the user about the result of the authentication process, such as via the UI of the client device. In this regard, if the credentials are valid, the response indicates successful authentication. If the credentials are invalid or the authentication fails for any reason, the response indicates unsuccessful authentication. Moreover, based on the response from at least one server, the system or application either grants access to the user or denies access. In this regard, if authentication is successful, the user is typically allowed to proceed to the requested resource. If unsuccessful, access is denied, and the user may be prompted to retry or take appropriate action.

A technical effect of the authentication of the credentials ensures that access to the encrypted files is securely managed and granted only to authorized users, aligning with the fundamental objective of maintaining a secure and controlled environment for the distributed encrypted database.

Optionally, the at least one server is configured to execute the database management system to further interact with a second platform to deploy and manage at least one containerized software application across a cluster of the at least one database node. In this regard, the at least one server further provides an additional functionality of seamless interaction of the third software with the second platform, to deploy and effectively manage at least one containerized software application across a cluster of the at least one database node. Thereby, implying that the system can distribute and manage software applications packaged in containers across a group of database nodes. The use of a cluster in this context leverages the collective computing power and resources of multiple nodes, allowing for improved performance and ensuring continuous availability of the database even if individual nodes encounter issues. Moreover, such additional interaction further enhances the scalability and efficiency of the system by enabling a smooth deployment and management of containerized software applications, thereby optimizing the performance of the database nodes within the distributed encrypted database.

Optionally, the second platform is the same as the first platform. In this regard, the first platform that is used for authentication purposes may also be utilized for deploying and managing containerized software applications. Therefore, the “second platform” in this context refers to a same or similar technology or system used for authentication as well as deploying and managing containerized applications, showcasing the system's efficiency and integration of functionalities.

The present disclosure also relates to the computer-implemented method as described above. Various embodiments and variants disclosed above, with respect to the aforementioned system apply mutatis mutandis to the computer-implemented method.

In an embodiment, the computer-implemented method further comprises executing the database management system for retrieving at least one encryption key that is employed to encrypt the data at rest, from a centralized repository.

In an embodiment, the computer-implemented method further comprises generating at least one customized policy for centralized key management at the centralized repository, wherein the at least one customized policy is employed when retrieving the at least one encryption key from the centralized repository.

In an embodiment, the computer-implemented method further comprises executing the database management system for:
receiving an access request from a client device, wherein the access request comprises credentials of a user;
sending an authentication request comprising the credentials, to the first platform that is capable of authenticating users of the distributed encrypted database; and
upon receiving a response indicative of successful authentication of the credentials from the first platform, granting the user with access to the encrypted files.

In an embodiment, the computer-implemented method further comprises executing the database management system for interacting with a second platform for deploying and managing at least one containerized software application across a cluster of the at least one database node.

The present disclosure also relates to the computer program product as described above. Various embodiments and variants disclosed above, with respect to the aforementioned system and the aforementioned computer-implemented method, apply mutatis mutandis to the computer program product.

### EXPERIMENTAL PART

In the healthcare sector, there is a critical need to protect sensitive patient data, such as medical records, personal information, and diagnostic reports. By implementing a distributed encrypted database solution, healthcare organizations ensured the confidentiality and integrity of patient data while maintaining high availability.

A hospital network with multiple locations and departments adopted the disclosed system. Each location had its own database node, configured with Patroni for high availability and automated failover. The Cybertec PostgreSQL plugin for encryption was employed to secure patient data at rest, ensuring that even if unauthorized access to the physical storage occurred, the sensitive information remains encrypted and unreadable.

To manage access and authentication within the distributed environment, the patched version of Envconsul with Kubernetes authentication support was utilized, allowing seamless integration with the hospital's Kubernetes cluster, enabling centralized authentication and access control for database resources. Only authorized healthcare professionals and staff members with valid credentials were granted access to the encrypted database.

Centralized key management using custom HashiCorp Vault policies had further enhanced the security of the setup. Vault had served as a secure repository for storing and managing encryption keys. Fine-grained access controls defined by the custom policies had ensured that only authorized personnel can access and manage the keys, reducing the risk of key compromise.

With such a distributed encrypted database solution in place, the healthcare organizations ensured the protection of patient data, met regulatory compliance requirements, and maintained high availability for critical healthcare systems. The solution provided a robust and secure infrastructure for storing and accessing sensitive healthcare information, safeguarding patient privacy and data confidentiality.

### DETAILED DESCRIPTION OF THE DRAWINGS

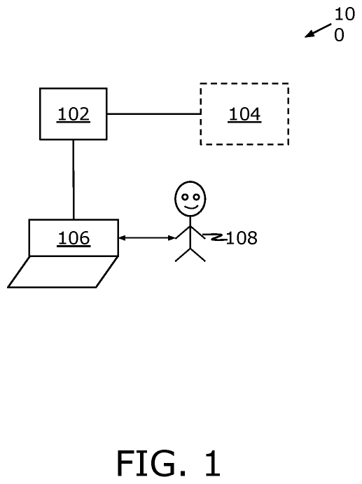

Referring to FIG. 1, illustrated is a system 100 for implementing a distributed encrypted database across database nodes of a distributed server network, in accordance with an embodiment of the present disclosure. The system comprises at least one server 102 configured to execute a database management system to configure at least one database node of the distributed encrypted database with a first software to provide automated failover and replication capabilities in the distributed encrypted database. Moreover, the database management system is executed to integrate a second software with the database management system and encrypt data at rest in a distributed encrypted database by employing the second software. Furthermore, the database management system is executed to integrate a third software with a first platform that is capable of authenticating users of the distributed encrypted database for controlling access to the encrypted files.

Moreover, at least one server 102 is configured to execute the database management system to further retrieve at least one encryption key that is employed to encrypt the data at rest, from a centralized repository 104.

Furthermore, the at least one server 102 is configured to execute the database management system 104 to further-receive an access request from a client device 106, wherein the access request comprises credentials of a user 108; send an authentication request comprising the credentials, to the first platform that is capable of authenticating users of the distributed encrypted database; and upon receiving a response indicative of successful authentication of the credentials from the first platform, grant the user with access to the encrypted files.

Furthermore, at least one server 102 is configured to execute the database management system to further interact with a second platform to deploy and manage at least one containerized software application across a cluster of the at least one database node, wherein the second platform is the same as the first platform.

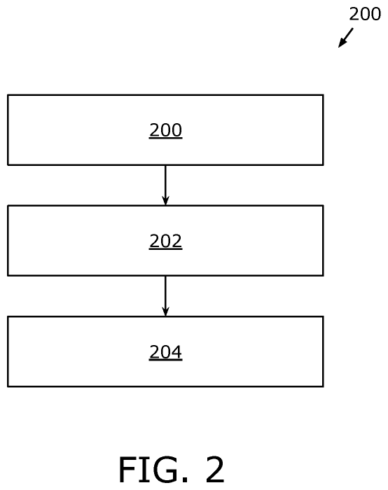

Referring to FIG. 2, illustrated is a flowchart 200 of steps of a computer-implemented method for implementing a distributed encrypted database across database nodes of a distributed server network, in accordance with an embodiment of the present disclosure.

At step 202, a database management system is executed for configuring at least one database node of the distributed encrypted database with a first software for providing automated failover and replication capabilities in the distributed encrypted database. At step 204, the database management system is executed for integrating a second software with the database management system and encrypting data at rest in a distributed encrypted database by employing the second software. At step 206, a database management system is executed for integrating a third software with a first platform that is capable of authenticating users of the distributed encrypted database for controlling access to the encrypted files.

1.-15. (canceled)

16. A system for implementing a distributed encrypted database across database nodes of a distributed server network, the system comprising at least one server configured to execute a database management system to:
configure at least one database node of the distributed encrypted database with a first software to provide automated failover and replication capabilities in the distributed encrypted database;
integrate a second software with the database management system and encrypt data at rest in distributed encrypted database by employing the second software; and
integrate a third software with a first platform that is capable of authenticating users of the distributed encrypted database for controlling access to the encrypted files.

17. A system of claim 16, wherein the data at rest in a distributed encrypted database is encrypted using a transparent data encryption algorithm.

18. A system of claim 16, wherein the at least one server is configured to execute the database management system to further retrieve at least one encryption key that is employed to encrypt the data at rest, from a centralized repository.

19. A system of claim 18, wherein the at least one server is further configured to generate at least one customized policy for centralized key management at the centralized repository, wherein the at least one customized policy is employed when retrieving the at least one encryption key from the centralized repository.

20. A system of claim 16, wherein the database management system applies a patch to the third software, prior to integrating the third software with the first platform.

21. A system of claim 16, wherein the at least one server is configured to execute the database management system to further:
receive an access request from a client device, wherein the access request comprises credentials of a user;
send an authentication request comprising the credentials, to the first platform that is capable of authenticating users of the distributed encrypted database; and
upon receiving a response indicative of successful authentication of the credentials from the first platform, grant the user with access to the encrypted files.

22. A system of claim 21, wherein the credentials comprise at least one of: a client certificate, an authentication token, a user identification, information related to a service account, information related to a role-based access control.

23. A system of claim 16, wherein the at least one server is configured to execute the database management system to further interact with a second platform to deploy and manage at least one containerized software application across a cluster of the at least one database node.

24. A system of claim 23, wherein the second platform is the same as the first platform.

25. A computer-implemented method for implementing a distributed encrypted database across database nodes of a distributed server network, the method comprising executing a database management system for:
configuring at least one database node of the distributed encrypted database with a first software for providing automated failover and replication capabilities in the distributed encrypted database;
integrating a second software with the database management system and encrypting data at rest in distributed encrypted database by employing the second software; and
integrating a third software with a first platform that is capable of authenticating users of the distributed encrypted database for controlling access to the encrypted files.

26. A computer-implemented method of claim 25, wherein further comprising executing the database management system for retrieving at least one encryption key that is employed to encrypt the data at rest, from a centralized repository.

27. A computer-implemented method of claim 26, wherein the method further comprises generating at least one customized policy for centralized key management at the centralized repository, wherein the at least one customized policy is employed when retrieving the at least one encryption key from the centralized repository.

28. A computer-implemented method of claim 25, further comprising executing the database management system for:
receiving an access request from a client device, wherein the access request comprises credentials of a user
sending an authentication request comprising the credentials, to the first platform that is capable of authenticating users of the distributed encrypted database; and
upon receiving a response indicative of successful authentication of the credentials from the first platform, granting the user with access to the encrypted files.

29. A computer-implemented method of claim 25, further comprising executing the database management system for interacting with a second platform for deploying and managing at least one containerized software application across a cluster of the at least one database node.

30. A computer program product comprising a non-transitory machine-readable data storage medium having stored thereon program instructions that, when executed by a processor, cause the processor to execute the steps of a computer-implemented method of claim 25.
